(19) United States
(12) Patent Application Publication
(10) Pub. No.: US 2023/0298076 A1
(43) Pub. Date: Sep. 21, 2023

(54) DYNAMIC GRATUITY RECOMMENDATION

(71) Applicant: INTERNATIONAL BUSINESS MACHINES CORPORATION, Armonk, NY (US)

(72) Inventors: Noah Zheutlin, White Plains, NY (US); Rohan R. Arora, Champaign, IL (US); Gerard Randolph Vanloo, White Plains, NY (US)

(21) Appl. No.: 17/655,408

(22) Filed: Mar. 18, 2022

(51) Int. Cl. G06Q 30/02

(52) U.S. Cl. CPC G06Q 30/0283

(57) ABSTRACT

A method, computer system, and a computer program product for providing gratuity recommendations is provided. The present invention may include receiving a service request from a user, wherein a service is to be provided according to the service request by a service provider. The present invention may include accessing data for the service request. The present invention may include determining a gratuity for the service request based on the data accessed for the service request. The present invention may include processing the gratuity according to preferences of the service provider.

### BACKGROUND

The present invention relates generally to the field of computing, and more particularly to knowledge based systems.

In the modern economy, users and/or consumers may request services through online platforms for various tasks, including, but not limited to, cleaning, furniture assembly, home repairs, errands, food delivery, amongst other services. The online platform may serve as an intermediary between the user and/or consumer and the service provider. A service provider may be an employee of the company providing the online platform, independent contractor, freelance worker, and/or other person willing to provide the service requested by the user and/or consumer.

Depending on the service provided a user and/or consumer may be prompted within the online platform to provide a tip and/or gratuity in addition to the charge for the requested service. These tips and/or gratuities may depend on a plurality of factors which may be able to be considered with the improvements to knowledge based systems by leveraging collaborative filtering, artificial intelligence, and machine learning techniques, among other things.

### SUMMARY

Embodiments of the present invention disclose a method, computer system, and a computer program product for gratuity recommendations. The present invention may include receiving a service request from a user, wherein a service is to be provided according to the service request by a service provider. The present invention may include accessing data for the service request. The present invention may include determining a gratuity for the service request based on the data accessed for the service request. The present invention may include processing the gratuity according to preferences of the service provider.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for gratuity recommendations according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for gratuity recommendations. As such, the present embodiment has the capacity to improve the technical field of providing gratuity recommendations by analyzing data related to a service request and providing dynamic recommendations based on a plurality of contributing factors. More specifically, the present invention may include receiving a service request from a user, wherein a service is to be provided according to the service request by a service provider. The present invention may include accessing data for the service request. The present invention may include determining a gratuity for the service request based on the data accessed for the service request. The present invention may include processing the gratuity according to preferences of the service provider.

As described previously, in the modern economy, users and/or consumers may request services through online platforms for various tasks, including, but not limited to, cleaning, furniture assembly, home repairs, errands, food delivery, amongst other services. The online platform may serve as an intermediary between the user and/or consumer and the service provider. A service provider may be an employee of the company providing the online platform, independent contractor, freelance worker, and/or other person willing to provide the service requested by the user and/or consumer.

Depending on the service provided a user and/or consumer may be prompted within the online platform to provide a tip and/or gratuity in addition to the charge for the requested service. These tips and/or gratuities may depend on a plurality of factors which may include factors the user and/or consumer fails to consider.

Therefore, it may be advantageous to, among other things, receive a service request from a user, wherein a service is to be provided according to the service request by a service provider, access data for the service request, determine a gratuity for the service based on the data accessed for the service request, and process the gratuity according to preferences of the service provider.

According to at least one embodiment, the present invention may improve the connection between users (e.g., consumers) and service providers by enabling users (e.g., consumers) to select a service provider based on information provided by the service provider in a service provider profile.

According to at least one embodiment, the present invention may enable service providers to achieve their goals more directly by providing direct payments for their services towards a goal designated by the service provider in a service provider profile.

According to at least one embodiment, the present invention may improve gratuity determinations by users (e.g., consumers) for services requested through an online platform by analyzing data related to the service request. Data related to a service request may include, but is not limited to including, tips from other users, tips for similar services, distance service provider may be required to travel, minimum wage of area, tip pooling, amongst other data related to the service request.

According to at least one embodiment, the present invention may improve gratuity recommendations by considering real time data in determining the gratuity for the service request. Real time data may include, but is not limited to including, user (e.g., consumer) satisfaction, travel duration of the service provider, physical exertion of the service provider, weather conditions, amongst other real time data related to the service request.

According to at least one embodiment, the present invention may improve gratuity payments by processing the gratuity according to preferences of the service provider. The preferences of the service provider may enable the service provider to allocate payments directly towards loans, wish lists, charitable organizations, amongst other expenses and/or causes.

According to at least one embodiment, the present invention may improve gratuity recommendations by dynamically adjusting gratuity determinations based on user rankings of a plurality of categories each corresponding to an explanatory variable.

According to at least one embodiment, the present invention may improve the functionality of computers by enabling faster computations for gratuities by leveraging one or more machine learning models which may allow for the efficient processing of large amounts of data (e.g., applying an amount of data beyond what may be comprehensible by a single person).

According to at least one embodiment, the present invention may improve the technical field of knowledge based systems by leveraging collaborative filtering, artificial intelligence, linear regression, amongst other machine learning techniques in providing gratuity recommendations to users which may be dynamically determined for each user.

According to at least one embodiment, the present invention may be implemented in an in-person place of service (e.g., a hair salon, a barber shop), with the user being enabled to input feedback relating to the service into the online platform (e.g., including details such as whether or not the service was satisfactory based on conditions such as service quality, timeliness, whether the service provider was cordial, whether the service provider was polite, among other factors which may influence a user's tip and/or gratuity determination). After inputting the feedback related to the service, the user may further indicate which factors should primarily influence the determination, and the present invention may accordingly recommend a tip and/or gratuity amount that may be in line with the user's preference. The system may further use machine learning to learn a user's preference and to adjust future recommendations accordingly.

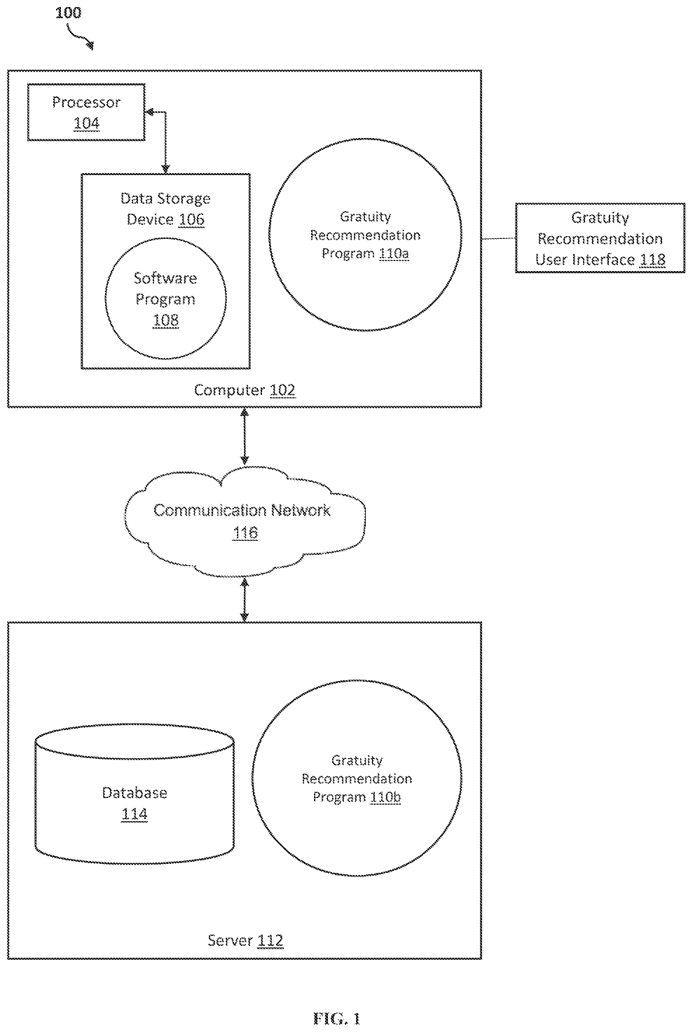

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a gratuity recommendation program 110a. The networked computer environment 100 may also include a server 112 that is enabled to run a gratuity recommendation program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

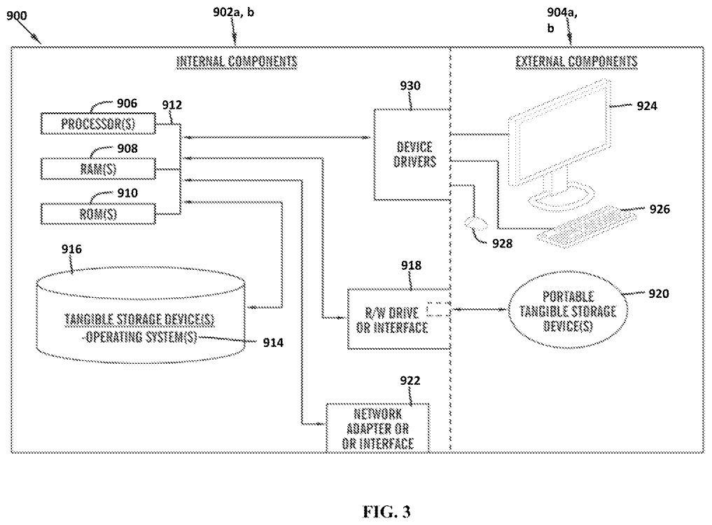

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the gratuity recommendation program 110a, 110b may interact with a database 114 that may be embedded in various storage devices, such as, but not limited to a computer/mobile device 102, a networked server 112, or a cloud storage service.

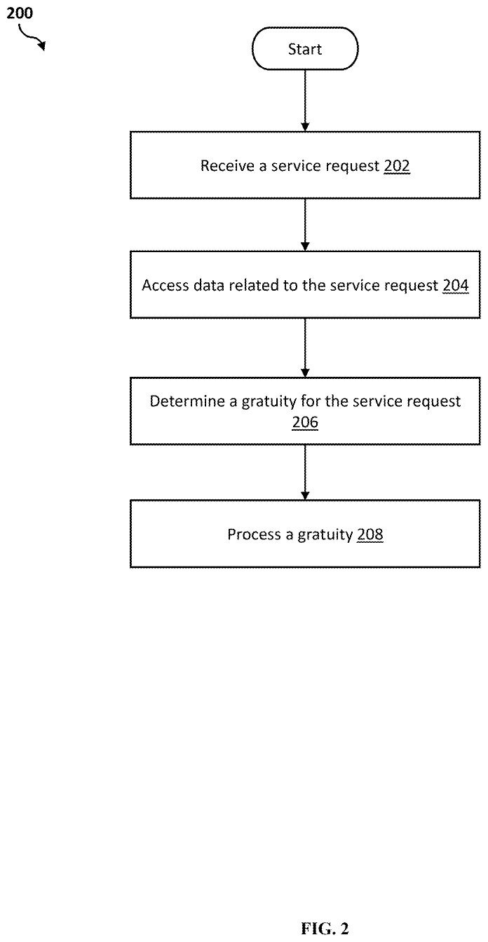

According to the present embodiment, a user using a client computer 102 or a server computer 112 may use the gratuity recommendation program 110a, 110b (respectively) to provide dynamic gratuity recommendations based on a plurality of contributing factors. The gratuity recommendation method is explained in more detail below with respect to FIG. 2.

Referring now to FIG. 2, an operational flowchart illustrating the exemplary gratuity recommendation process 200 used by the gratuity recommendation program 110a and 110b (hereinafter gratuity recommendation program 110) according to at least one embodiment is depicted.

At 202, the gratuity recommendation program 110 receives a service request. The service request may be requested by a user (e.g., consumer) through an online platform, wherein a service is to be provided by a service provider according to the service request. The online platform may serve as an intermediary between the user (e.g., consumer) and a service provider. The service provider may be an employee of the company providing the online platform, an independent contractor, a freelance worker, and/or other person willing to provide the service requested by the user and/or consumer. The user (e.g., consumer) may request services such as, but not limited to, cleaning, furniture assembly, home repairs, errands, food delivery, assistance moving, amongst other services.

The user (e.g., consumer) may request the service in a gratuity recommendation user interface 118 which may be displayed by the gratuity recommendation program 110 as an integration with a software application, such as, a dedicated software application or third party software application (e.g., service company software application). The third party software application (e.g., service company software application) may integrate with and/or source the gratuity recommendation program 110 which may be maintained by a cloud based service, such as, but not limited to, IBM Cloud® (IBM Cloud® and all IBM-based trademarks are trademarks or registered trademarks of International Business Machines Corporation in the United States, and/or other countries), amongst other cloud based services. The cloud based service may utilize public cloud, private cloud, and/or hybrid cloud.

The gratuity recommendation program 110 may recommend one or more service providers to the user (e.g., consumer). The gratuity recommendation program 110 may recommend the one or more service providers to the user (e.g., consumer) based on at least, the service request, reviews of the one or more service providers, location of the one or more service providers, amongst other factors. As will be explained in more detail below, the gratuity recommendation program 110 may utilize the service provider selected by the user (e.g., consumer) from the one or more service providers in providing more personalized recommendations to the user (e.g., consumer) for future service requests.

Each of the one or more service providers may have a service provider profile. The service provider profile may include, but is not limited to including, information provided by the service provider, service provider preferences, hyperlinks, preferences as to payment method and/or how gratuity and/or service payments may be applied, amongst other information. The gratuity recommendation program 110 may provide an opt-in mechanism prior receiving any information of the service provider. The gratuity recommendation program 110 may also enable the service provider to opt-out at any time. Both the opt-in and opt-out mechanisms may be controlled by the service provider in the gratuity recommendation user interface 118. The gratuity recommendation program 110 may not store, access, and/or utilize any information provided by the service provider without consent from the service provider.

The profile of the one or more service providers may include information about the service provider which may enable the user (e.g., consumer) to make an informed decision when selecting a service provider from the one or more service providers provided by the gratuity recommendation program 110. All information included in the profile of the one or more service providers shall not be construed as to violate or encourage the violation of any local, state, federal, or international law with respect to privacy protection. No information included in the service provider profile may be stored by the gratuity recommendation program 110 without the expressed consent of the service provider. The service provider may add and/or delete information from their service provider profile in the gratuity recommendation user interface 118 at any time. The gratuity recommendation program 110 may also periodically display prompts to the service provider detailing the information being shared by the service provider. The prompts may enable the service provider to stop sharing and/or update information previously provided by the service provider.

The service provider may include personalized information within the service provider profile relating to goals and/or objectives the service provider may aim to achieve by providing the service. The gratuity recommendation program 110 may enable the service provider to verify information provided within the service provider profile such that the user (e.g., consumer) may rely on the information as authentic. For example, the gratuity recommendation program 110 may enable the service provider to link a third party service such as loan provider and/or charity donation page such that payments from the user (e.g., consumer) may be allocated directly. The gratuity recommendation program 110 may also display an icon and/or other visual symbol representing that the information provided by the service provider as well as an additional icon as to whether the information provided has been authenticated.

The information provided by the service provider may be displayed to the user (e.g., consumer) through one or more icons and/or visual displays in the gratuity recommendation user interface 118. The service provider may also utilize different preferences through the service provider profile, such as, but not limited to, enabling direct payments corresponding to the information provided in the service provider profile, customizing how payments received from the user (e.g., consumer) may be allocated, and/or limiting and/or enabling users of the online platform to view information in the service provider profile. Users of the online platform may only be able to view information in the service provider profile for which the service provider consented.

The gratuity recommendation program 110 may utilize the selections of the users in recommending service providers in the future for additional service requests. The users may further include details with respect to a reasoning for choosing a particular service provider, to assist the gratuity recommendation program 110 in recommending a service provider for a future service request. The users may provide further details to the gratuity recommendation program 110 in the gratuity recommendation user interface 118.

In an embodiment, the gratuity recommendation program 110 may also be utilized for in-person services, such as, but not limited to, dining, hair care, tutoring, pet training, fitness classes, amongst other in-person services. In this embodiment, the gratuity recommendation program 110 may utilize a plurality of prompts in receiving data related to the service from the user (e.g., consumer). The plurality of prompts displayed to the user (e.g., consumer) by the gratuity recommendation program 110 in the gratuity recommendation user interface 118 may be specific to the in-person service. The prompts may include, but are not limited to including, ratings for specific aspects of the in-person service as well as text feedback. In this embodiment the gratuity recommendation program 110 may utilize at least the linguistic analysis techniques detailed in step 206 in analyzing the text feedback received from the user (e.g., consumer) to provide a gratuity recommendation. Additionally, the gratuity recommendation program 110 may utilize the text feedback in generating additional prompts specific to the un-person service which may be utilized for other users (e.g., consumer) for future in-person services.

At 204, the gratuity recommendation program 110 receives and/or accesses data related to the service request. The gratuity recommendation program 110 may receive and/or access data received from a mobile device, a telephone, a personal digital assistant, a laptop computer, a desktop computer, or any other computing device which the user (e.g., consumer) may be utilizing in requesting the service and/or the service provider may be utilizing in receiving the service request.

The gratuity recommendation program 110 may also receive data from one or more smart wearable devices associated with the service provider, vehicles or means of transportation associated with the service provider, amongst other Internet of Things (IoT) computing devices capable of transmitting data to the gratuity recommendation program 110. The gratuity recommendation program may only receive data from devices associated with the service provider in which the service provider has consented to share. The service provider may manage the devices in which the gratuity recommendation program 110 may receive data in the gratuity recommendation user interface 118.

The gratuity recommendation program 110 may also access data with respect to the service request from one or more publicly available resources and/or data stored in a knowledge corpus (e.g., database 114). Data that may be accessed from the one or more publicly available resources which may be stored in the knowledge corpus (e.g., database 114) may include, but is not limited to including, state and/or federal minimum wage requirements, weather conditions, amongst other data. All data received, accessed, and/or stored by the gratuity recommendation program 110 may not violate nor be construed to violate any local, state, federal, or international law with respect to privacy protection.

Data related to the service request may include both data and/or real time data related to the service request. Data related to the service request may include, but is not limited to including, tips from other users, tips for similar services, distance service provider may be required to travel, minimum wage of area, tip pooling, amongst other data related to the service request. As will be explained in more detail below with respect to step 206, data related to the service request may be utilized by the gratuity recommendation program 110 in determining a baseline gratuity amount. The baseline gratuity amount may be specific to the user and updated as the user requests additional services. The baseline gratuity amount may be dynamically adjusted based on real time data related to the service request as the service provider starts and/or completes the service requested by the user (e.g., consumer). Real time data related to the service request may include, but is not limited to including, user (e.g., consumer) satisfaction, travel duration of the service provider, physical exertion of the service provider, weather conditions, amongst other real time data related to the service request. Data received and/or accessed may be different depending on the service requested by the user.

At 206, the gratuity recommendation program 110 determines a gratuity for the service request. The gratuity recommendation program 110 may determine the gratuity for the service request utilizing a set of gratuity recommendation rules and/or one or more machine learning models. The gratuity recommendation program 110 may apply the gratuity recommendation rules and/or one or more machine learning models to the data received and/or accessed for the service request at step 204. The gratuity recommendation program 110 may apply the gratuity recommendation rules and/or the one or more machine learning models differently to the data received and/or accessed depending on the service request and/or preferences of the user.

The gratuity recommendation rules may be rules by which the gratuity recommendation program 110 determines the baseline gratuity amount based on data related to the service request and/or rules by which the gratuity recommendation program 110 may adjust the baseline gratuity based on the real time data related to the service request which may be received continuously from the time the service provider starts the service request through completion of the service request. The real time data may be received from at least a computing device associated with the service provider, one or more smart wearable devices associated with the service provider, vehicles and/or other means of transportation associated with the service provider, amongst other IoT computing devices associated with the service provider which may be capable of transmitting data to the gratuity recommendation program 110. The gratuity recommendation rules may be pre-determined parameters by which the baseline gratuity may be determined and/or the baseline gratuity may be adjusted. The gratuity recommendation rules may be pre-determined amounts and/or percentage change adjustments which may be dynamically adjusted for each user of the gratuity recommendation program 110. The gratuity recommendation rules may be adjusted automatically by the gratuity recommendation program 110 based on feedback received from the user and/or adjusted directly by the user in the gratuity recommendation user interface 118.

Users may directly adjust the gratuity recommendation rules amongst other preferences in the recommendation user interface 118 by at least ranking a plurality of categories related to service requests. The categories may correspond to the data received and/or accessed for the service request at step 204. As will be explained in more detail below with respect to the linear regression model, each of the plurality of categories ranked by the user may correspond to an explanatory variable. The gratuity recommendation program 110 may adjust the slope coefficient to be applied to the explanatory variable based on the rankings by the user. The user may provide different rankings for different services. For example, the user may rank timeliness highest for food delivery requests and rank user satisfaction the highest for home repairs. The gratuity recommendation program 110 may additionally utilize the rankings of the plurality of categories for each different service in determining the gratuity recommendation rules to be applied to a service the user has not previously requested.

The gratuity recommendation program 110 may also utilize one or more machine learning models in determining the gratuity for the service request. The one or more machine learning algorithms utilized by the gratuity recommendation program 110 may include, but are not limited to including, collaborative filtering, content-based filtering, linear regression, amongst other machine learning models. The gratuity recommendation program 110 may utilize collaborative filtering (e.g., user-user collaborative filtering), content-based filtering (e.g., service-service collaborative filtering), and/or a hybrid of the two. The gratuity recommendation program 110 may utilize collaborative filtering in determining the gratuity for the service request based on other users. For example, other users who ordered a $20 dollar meal from this restaurant typically tipped $4 dollars and/or 20 percent. The gratuity recommendation program 110 may utilize content-based filtering in determining the gratuity for the service request based on other users who may have requested a similar service. For example, other users who had their TV mounted in this area typically tipped 15 percent.

The gratuity recommendation program 110 may also utilize a linear regression machine learning model in determining the gratuity for the service request based on the user's (e.g., consumers) past gratuities. The gratuity recommendation program 110 may utilize the following multiple linear regression equation:

yᵢ=β₀+β₁xᵢ₁+β₂xᵢ₂+ . . . +βₚxᵢₚ+ϵ

In the above equation yᵢ may represent the dependent variable which may be the gratuity, xᵢ may represent one or more explanatory variables which may be based on the data received by the gratuity recommendation program 110, β₀ may represent the y-intercept and/or a constant term utilized in determining the gratuity, βₚ may represent slope coefficients for each of the one or more explanatory variables, and E may represent the model's error term (e.g., residuals). The gratuity recommendation program 110 may utilize the data received and/or accessed at step 204 in determining the gratuity, the gratuity may be determined using each of the one or more explanatory variables which may affect the gratuity and/or dependent variable.

For example, the gratuity recommendation program 110 may receive and/or access data such as the distance between a service provider and the user (e.g., consumer), time of travel for the service provider to the user, user (e.g., consumer) satisfaction and/or feedback, and physical exertion data received from a smart wearable device associated with the user. Each of these may be utilized as an explanatory variable by the gratuity recommendation program 110. The gratuity recommendation program 110 may utilize values from the set of gratuity recommendation rules in applying the slope coefficients for each of the one or more explanatory variables. In this example, the gratuity recommendation program 110 may have received data from the smart wearable device associated with the user showing a high level of physical exertion in performing the service. The data may be converted into a value on a scale which in this case may be 7 out of 10. The gratuity recommendation rules may have a slope coefficient for the explanatory variable of physical exertion of 10 percent. Accordingly, the 7 for physical exertion may be multiplied by a value of 0.1 equating to a value of 0.7. The same may be done for the remaining explanatory variables which may be added together with the model's error term in determining the gratuity for the service.

The gratuity recommendation program 110 may also utilize a neural network in determining a gratuity. The neural network may be trained utilizing data stored in a knowledge corpus (e.g., database). The gratuity recommendation program 110 may utilize data stored in the knowledge corpus (e.g., database 114) specific to the user (e.g., consumer) if the user (e.g., consumer) exceeds a threshold data value. The threshold data value may be exceeded for the user (e.g., consumer) based on the number of previous services requested by the user utilizing the gratuity recommendation program 110. Alternatively, the gratuity recommendation program 110 may utilize data stored in the knowledge corpus (e.g., database 114) with respect to other users of the gratuity recommendation program 110. The gratuity recommendation program 110 may utilize one or more machine learning techniques in training the neural network based on the data stored in the knowledge corpus (e.g., database 114). The one or more machine learning techniques which may be utilized by the gratuity recommendation program 110 in training the neural network may include, but are not limited to including, stochastic gradient descent and/or back propagation, amongst other machine learning techniques. The gratuity recommendation program 110 may utilize the data received and/or accessed as input for the neural network, wherein output may be the gratuity recommended for the service.

The gratuity recommendation program 110 may determine the gratuity for the service request utilizing at least the set of gratuity recommendation rules and/or one or more of at least the machine learning models described above. For example, a user may request a service and select a service provider in the gratuity recommendation user interface. The gratuity recommendation program 110 may utilize collaborative filtering in determining the baseline gratuity amount based on other user(s) who have requested a similar service. The gratuity recommendation program 110 may also utilize data related to the service request and the gratuity recommendation rules in determining the baseline gratuity amount. The baseline gratuity amount may be increased based on the service provider being required to travel over 10 miles, among other factors. The gratuity recommendation program 110 may further adjust the baseline gratuity amount continuously as real time data is received. In this example, the gratuity recommendation program 110 may receive data from a smart wearable device associated with the service provider. The data received from the smart wearable device may indicate high levels of physical exertion based on heart rate. Accordingly, the gratuity recommendation program 110 may adjust the baseline gratuity amount 2 percent based on the smart wearable data received, the 2 percent increase being the baseline parameter pre-determined percent change adjustment within the gratuity recommendation rules.

The user (e.g., consumer) may enable the gratuity recommendation program to automatically adjust the baseline gratuity amount and/or enable the gratuity recommendation program 110 to present the user (e.g., consumer) one or more prompts based on the real time data which may enable the user (e.g., consumer) to manually adjust the gratuity amount based on the data received, accept and/or deny a recommended adjustment according to the gratuity recommendation rules, amongst other prompts which may be presented to the user in the gratuity recommendation user interface 118. For example, the user (e.g., consumer) may receive a prompt with a recommended percentage increase in the baseline gratuity based on adverse weather conditions, based on the user's increased percentage in the baseline gratuity in similar weather conditions in the past. The user (e.g., consumer) may accept, deny, and/or manually select a gratuity adjustment based on the prompt received within the gratuity recommendation user interface 118.

In another embodiment, the gratuity recommendation program 110 may not present the gratuity to the user until user feedback may be received. In this embodiment, the gratuity for the service request may be continuously updated utilizing the gratuity recommendation rules and/or one or more machine learning models until the service is completed by the service provider. The gratuity recommendation program 110 may analyze user feedback utilizing one or more linguistic analysis techniques, such as, but not limited to a machine learning model with Natural Language Processing (NLP), amongst other linguistic analysis techniques, such as those implemented in IBM Watson® (IBM Watson and all Watson-based trademarks are trademarks or registered trademarks of International Business Machines Corporation in the United States, and/or other countries), IBM Watson® Speech to Text, IBM Watson® Tone Analyzer, IBM Watson® Natural Language Understanding, IBM Watson® Natural Language Classifier, amongst other linguistic analysis techniques in analyzing feedback received from the user. The gratuity recommendation program 110 may utilize the feedback received from the user in recommending one or more service providers for future service requests and/or dynamically adjusting the gratuity recommendation rules for the user. For example, the user may record an audio message reviewing the service provider. Utilizing linguistic techniques detailed above the gratuity recommendation program 110 may determine the user was disappointed with the amount of time it took for the service provider to complete the service request, among other factors. The gratuity recommendation program 110 may boost the ranking of the category related to timeliness for the user, increase the slope coefficient for the explanatory variable related to timeliness, and recommend service providers for future service requests.

The gratuity recommendation program 110 may display the recommended gratuity to the user (e.g., consumer) in the gratuity recommendation user interface 118. The user (e.g., consumer) may also receive a breakdown as to how the gratuity recommendation may have been determined including adjustments prior to approving the gratuity for processing.

In an embodiment, the gratuity recommendation program 110 may present the user (e.g., consumer) one or more prompts based on the real time data which may enable the user (e.g., consumer) to manually adjust the gratuity amount based on the data received, accept and/or deny a recommended adjustment according to the gratuity recommendation rules, amongst other prompts which may be presented to the user in the gratuity recommendation user interface 118. The gratuity recommendation program 110 may store recommended gratuity and the final gratuity manually adjusted by the user and/or gratuities accepted and/or denied by the user in the knowledge corpus (e.g., database 114). The gratuity recommendation program 110 may present the user (e.g., consumer) with one or more reminders related to the gratuity at a frequency which may be configured by the user (e.g., consumer) in the gratuity recommendation user interface 118. The gratuity recommendation program 110 may additionally utilize the prompt responses of the user in adjusting the gratuity recommendation rules. For example, the gratuity recommendation program 110 may present the user 5 prompts related to inclement weather for 5 different service requests. For each of the service requests the user may increase the gratuity above the recommended adjustment presented by the gratuity recommendation program 110. The gratuity recommendation program 110 may increase the slope coefficient for the explanatory variable related to inclement weather to reflect the average of the 5 increase amounts provided manually by the user.

At 208, the gratuity recommendation program 110 processes the gratuity. The gratuity recommendation program 110 may process the gratuity for the service requested based on the gratuity determined at step 206. The gratuity determined at step 206 may require user (e.g., consumer) approval prior to the gratuity being processed. The gratuity recommendation program 110 may process the gratuity payment utilizing payment processing infrastructure integrated with the dedicated software application and/or the third party software application (e.g., service company software application).

The gratuity recommendation program 110 may process the gratuity according to the preferences of the service provider. The service provider may utilize different preferences through their service provider profile in at least, enabling direct payments corresponding to information provided in their service provider profile, customizing how gratuity payments may be processed and/or allocated, amongst other preferences. For example, a service provider may enable direct payments to a charitable organization for a portion of all gratuities received for services provided. The user (e.g., consumer) may approve a gratuity recommendation determined by the gratuity recommendation program 110 for $10. Based on the preferences of the service provider 25 percent of gratuities may be allocated to a charitable organization. The gratuity recommendation program 110 may automatically donate the 25 percent to the charitable organization and the remaining 75 percent to the service provider. The gratuity recommendation program 110 may further enable the user (e.g., consumer) to provide a separate donation to the charitable organization.

The gratuity recommendation program 110 may record and/or store each charitable and/or other allocation made by users (e.g., consumers) and service providers. The gratuity recommendation program 110 may record and/or store each allocation in the knowledge corpus (e.g., database 114). Each user (e.g., consumer) and/or service provider may access their records with respect to allocations within the gratuity recommendation user interface 118. The gratuity recommendation program 110 may also transmit the records to the user at the end of each fiscal year.

It may be appreciated that FIG. 2 provides only an illustration of one embodiment and do not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the gratuity recommendation program 110a in client computer 102, and the gratuity recommendation program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the gratuity recommendation program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the gratuity recommendation program 110a in client computer 102 and the gratuity recommendation program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the gratuity recommendation program 110a in client computer 102 and the gratuity recommendation program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

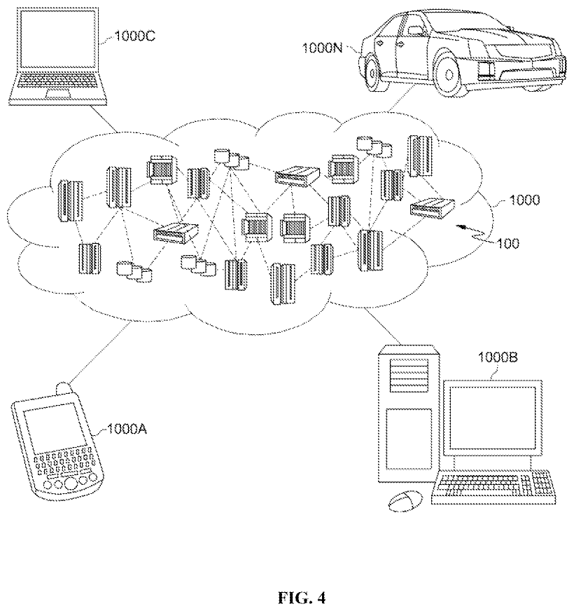

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

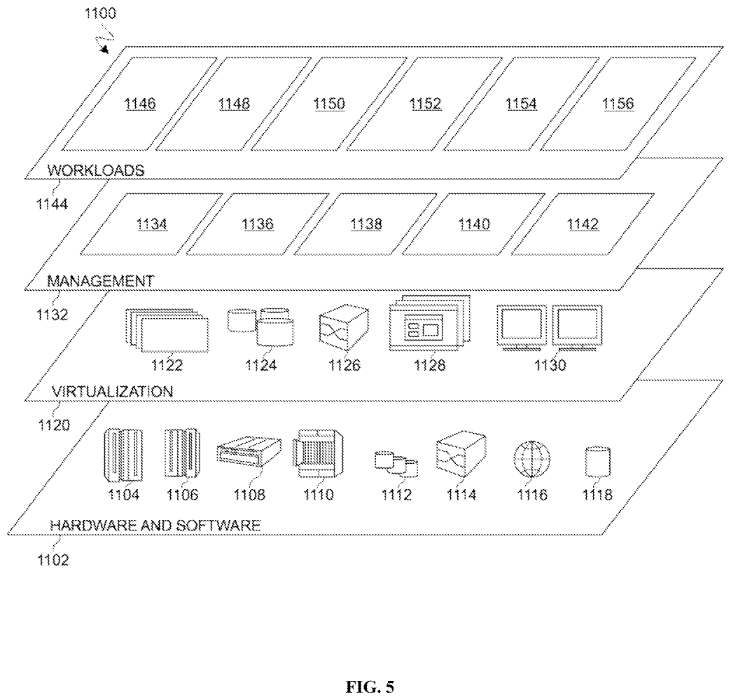

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and the gratuity recommendation program 1156. A gratuity recommendation program 110a, 110b provides a way to provide gratuity recommendations by analyzing data related to a service request and providing dynamic recommendations based on a plurality of contributing factors.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for providing gratuity recommendations, the method comprising:
receiving a service request from a user, wherein a service is to be provided by a service provider according to the service request;
accessing data for the service request;
determining a gratuity for the service based on the data accessed for the service request; and
processing the gratuity according to preferences of the service provider.

2. The method of claim 1, wherein the gratuity is determined utilizing a set of gratuity recommendation rules and one or more machine learning models.

3. The method of claim 2, wherein the set of gratuity recommendation rules and the one or more machine learning models are utilized in determining a baseline gratuity, wherein the baseline gratuity is adjusted based on real time data received.

4. The method of claim 1, wherein the service provider is selected by the user from a list of one or more service providers recommended to the user.

5. The method of claim 4, wherein the list of the one or more service providers includes information about each of the one or more service providers, the information being provided by each of the one or more service providers in a gratuity recommendation user interface.

6. The method of claim 1, wherein the data accessed for the service request includes real time data received continuously throughout a performance of the service from one or more IoT devices associated with the service provider.

7. The method of claim 1, wherein the gratuity determined is presented to the user in a recommendation user interface for approval.

8. A computer system for providing gratuity recommendations, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a service request from a user, wherein a service is to be provided by a service provider according to the service request;
accessing data for the service request;
determining a gratuity for the service based on the data accessed for the service request; and
processing the gratuity according to preferences of the service provider.

9. The computer system of claim 8, wherein the gratuity is determined utilizing a set of gratuity recommendation rules and one or more machine learning models. request; and

10. The computer system of claim 9, wherein the set of gratuity recommendation rules and the one or more machine learning models are utilized in determining a baseline gratuity, wherein the baseline gratuity is adjusted based on real time data received.

11. The computer system of claim 8, wherein the service provider is selected by the user from a list of one or more service providers recommended to the user.

12. The computer system of claim 11, wherein the list of the one or more service providers includes information about each of the one or more service providers, the information being provided by each of the one or more service providers in a gratuity recommendation user interface.

13. The computer system of claim 8, wherein the data accessed for the service request includes real time data received continuously throughout a performance of the service from one or more IoT devices associated with the service provider.

14. The computer system of claim 8, wherein the gratuity determined is presented to the user in a recommendation user interface for approval.

15. A computer program product for providing gratuity recommendations, comprising:
one or more non-transitory computer-readable storage media and program instructions stored on at least one of the one or more tangible storage media, the program instructions executable by a processor to cause the processor to perform a method comprising:
receiving a service request from a user, wherein a service is to be provided by a service provider according to the service request;
accessing data for the service request;
determining a gratuity for the service based on the data accessed for the service request; and
processing the gratuity according to preferences of the service provider.

16. The computer program product of claim 15, wherein the gratuity is determined utilizing a set of gratuity recommendation rules and one or more machine learning models.

17. The computer program product of claim 16, wherein the set of gratuity recommendation rules and the one or more machine learning models are utilized in determining a baseline gratuity, wherein the baseline gratuity is adjusted based on real time data received.

18. The computer program product of claim 15, wherein the service provider is selected by the user from a list of one or more service providers recommended to the user.

19. The computer program product of claim 18, wherein the list of the one or more service providers includes information about each of the one or more service providers, the information being provided by each of the one or more service providers in a gratuity recommendation user interface.

20. The computer program product of claim 15, wherein the data accessed for the service request includes real time data received continuously throughout a performance of the service from one or more IoT devices associated with the service provider.
